(19) United States
(12) Patent Application Publication
(10) Pub. No.: US 2012/0183016 A1
(43) Pub. Date: Jul. 19, 2012

(54) TEMPERATURE DETECTION CIRCUIT AND SENSOR DEVICE

(75) Inventor: Masahiro KANAI, Suwa-shi (JP)

(73) Assignee: SEIKO EPSON CORPORATION, Tokyo (JP)

(21) Appl. No.: 13/331,201

(22) Filed: Dec. 20, 2011

(30) Foreign Application Priority Data
Jan. 17, 2011 (JP) 2011-006818

(51) Int. Cl. G01K 7/00

(52) U.S. Cl. 374/163; 374/E07.001

(57) ABSTRACT

A temperature detection circuit capable of generating a temperature detection voltage with reduced noise level, and a sensor device using the same are provided. The temperature detection circuit includes a temperature detection voltage generator that generates a first temperature detection voltage of which the voltage level based on a reference voltage varies according to the temperature; a temperature detection voltage inverter that inverts the first temperature detection voltage on the basis of the reference voltage, and amplifies or attenuates the first temperature detection voltage to generate a second temperature detection voltage; and a temperature detection voltage adder that adds up the first temperature detection voltage and the second temperature detection voltage.

The entire disclosure of Japanese Patent Application No. 2011-006818, filed Jan. 17, 2011 is expressly incorporated by reference herein.

### BACKGROUND

1. Technical Field

The present invention relates to a temperature detection circuit and a sensor device.

2. Related Art

With the advancement of technology in recent years, a variety of sensors is used in various apparatuses and systems. There are digital output and analog output sensors. In the analog output sensors, generally, an output voltage varies according to the detection value on the basis of a voltage (direct-current bias voltage) when a predetermined reference value is detected. For example, in a gyroscope sensor, when there is no input (angular velocity is 0), the direct-current bias voltage is output, and the output voltage varies according to the magnitude of the angular velocity. Generally, this direct-current bias voltage has almost linear characteristics with respect to temperature, and if the temperature varies, the direct-current bias voltage varies. In the case of the gyroscope sensor, a problem occurs in that the voltage is output as if the angular velocity is applied in spite of no application of the angular velocity. This problem can be solved by detecting environmental temperature (ambient temperature) using a temperature sensor, and performing temperature compensation according to the temperature (for example, JP-A-2007-292580).

Meanwhile, in a case where a temperature sensor is built into a sensor IC, a temperature sensor using a PN junction band gap is used, and the temperature detection voltage that the temperature sensor outputs is changed to an arbitrary temperature coefficient using an inverting amplifier or the like, and supplied to a circuit block that requires temperature correction. However, since the noise level of this temperature detection voltage is large, this noise level should be reduced particularly in an IC that requires low noise.

### SUMMARY

An advantage of some aspects of the invention is to provide a temperature detection circuit that can generate a temperature detection voltage with reduced noise level, and a sensor device using the same.

(1) An aspect of the invention is directed to a temperature detection circuit including a temperature detection voltage generator that generates a first temperature detection voltage of which the voltage level based on a given reference voltage varies according to the temperature; temperature detection voltage inverter that inverts the first temperature detection voltage on the basis of the reference voltage, and amplifies or attenuates the inverted first temperature detection voltage with a given gain to generate a second temperature detection voltage; and a temperature detection voltage adder that adds up the first temperature detection voltage and the second temperature detection voltage.

According to the aspect of the invention, since the noise superimposed on the first temperature detection voltage and the noise superimposed on the second temperature detection voltage ideally differ by 180° in phase, the noise level can be reduced by adding up the first temperature detection voltage and the second temperature detection voltage by the temperature detection voltage adder.

The temperature coefficient of the temperature detection voltage obtained by adding up the first temperature detection voltage and the second temperature detection voltage by the temperature detection voltage adder varies according to the gain of the temperature detection voltage inverter. Accordingly, according to the aspect of the invention, the temperature coefficient of the temperature detection voltage obtained by the temperature detection voltage adder can be set to a desired value by appropriately setting the gain of the temperature detection voltage inverter. In so doing, for example, the temperature detection voltage that the temperature detection circuit of the aspect of the invention outputs can be used as a temperature compensation voltage as is.

(2) Another aspect of the invention is directed to a temperature detection circuit including a temperature detection voltage generator that generates a first temperature detection voltage of which the voltage level based on a first reference voltage as varies according to the temperature; a temperature detection voltage converter that amplifies or attenuates the first temperature detection voltage on the basis of the first reference voltage to convert the amplified or attenuated first temperature detection voltage into a second temperature detection voltage; a reference voltage converter that converts the second temperature detection voltage into a third temperature detection voltage of which the voltage level based on a second reference voltage varies according to the temperature; a temperature detection voltage inverter that inverts the third temperature detection voltage on the basis of the second reference voltage, and amplifies or attenuates the inverted third temperature detection voltage with a given gain to generate a fourth temperature detection voltage; and a temperature detection voltage adder that adds up the third temperature detection voltage and the fourth temperature detection voltage.

According to the aspect of the invention, since the noise superimposed on the third temperature detection voltage and the noise superimposed on the fourth temperature detection voltage ideally differ by 180° in phase, the noise level can be reduced by adding up the third temperature detection voltage and the fourth temperature detection voltage by the temperature detection voltage adder.

The temperature coefficient of the temperature detection voltage obtained by adding up the third temperature detection voltage and the fourth temperature detection voltage by the temperature detection voltage adder varies according to the gain of the temperature detection voltage inverter. Accordingly, according to the aspect of the invention, the temperature coefficient of the temperature detection voltage obtained by the temperature detection voltage adder can be set to a desired value by appropriately setting the gain of the temperature detection voltage inverter. By operating in this way, for example, the temperature detection voltage that the temperature detection circuit of the aspect of the invention outputs can be used as a temperature compensation voltage as is.

Moreover, according to the aspect of the invention, the reference voltage (the second reference voltage) of the third temperature detection voltage can be set to an arbitrary voltage regardless of the first reference voltage using the reference voltage converter. Thereby, since the reference voltage of the temperature detection voltage obtained by the temperature detection voltage adder is also set to the second reference voltage, for example, the design of the temperature compensation circuit can be facilitated, for example, by making the second reference voltage the same voltage as the analog ground voltage of the temperature compensation circuit.

(3) In the temperature detection circuit, the reference voltage converter may amplify or attenuate the difference between the first temperature detection voltage and the second temperature detection voltage on the basis of the second reference voltage to generate the third temperature detection voltage.

The reference voltage of the temperature detection voltage can be easily converted into the second reference voltage from the first reference voltage by amplifying or attenuating the difference between the first temperature detection voltage and the second temperature detection voltage on the basis of the second reference voltage in this way.

(4) In the temperature detection circuit, the temperature detection voltage converter may invert and amplify or attenuate the first temperature detection voltage on the basis of the first reference voltage, to generate the second temperature detection voltage.

The noise level of the third temperature detection voltage obtained by the reference voltage converter can be reduced by inverting the first temperature detection voltage by the reference voltage converter to generate the second temperature detection voltage.

(5) In the temperature detection circuit, the gain of the temperature detection voltage inverter may be variable.

According to this temperature detection circuit, the temperature coefficient of the temperature detection voltage obtained by the temperature detection voltage adder can be adjusted by adjusting the gain of the temperature detection voltage inverter. For example, the temperature coefficient of the temperature detection voltage obtained by the temperature detection voltage adder can be kept almost constant by appropriately changing the gain of the temperature detection voltage inverter so as to correspond to a variation in the temperature coefficient of the temperature detection voltage that the temperature detection voltage generator generates.

(6) Still another aspect of the invention is directed to a sensor device including any of the above temperature detection circuits.

### BRIEF DESCRIPTION OF THE DRAWINGS

The invention will be described with reference to the accompanying drawings, wherein like numbers reference like elements.

FIG. 1 is a functional block diagram of a temperature detection circuit of a first embodiment.

FIG. 2 is a view showing a specific configuration example of the temperature detection circuit of the first embodiment.

FIG. 3 is a view showing a configuration example of a band gap reference circuit.

FIGS. 4A to 4C are views showing examples of the temperature characteristics of the temperature detection circuit of the first embodiment.

FIG. 5 is a functional block diagram of a temperature detection circuit of a second embodiment.

FIG. 6 is a view showing a specific configuration example of the temperature detection circuit of the second embodiment.

FIGS. 7A to 7F are views showing an example of the temperature characteristics of the temperature detection circuit of the second embodiment.

FIG. 8 is a view showing a configuration example of an angular velocity detecting device that is an example of a sensor device.

### DESCRIPTION OF EXEMPLARY EMBODIMENTS

Preferred embodiments of the invention will be described below in detail with reference to the drawings. In addition, the embodiments to be described below do not unreasonably limit the contents of the invention set forth in the claims. Additionally, all components described below are not indispensable constituent conditions of the invention.

### 1. Temperature Detection Circuit

### (1) First Embodiment

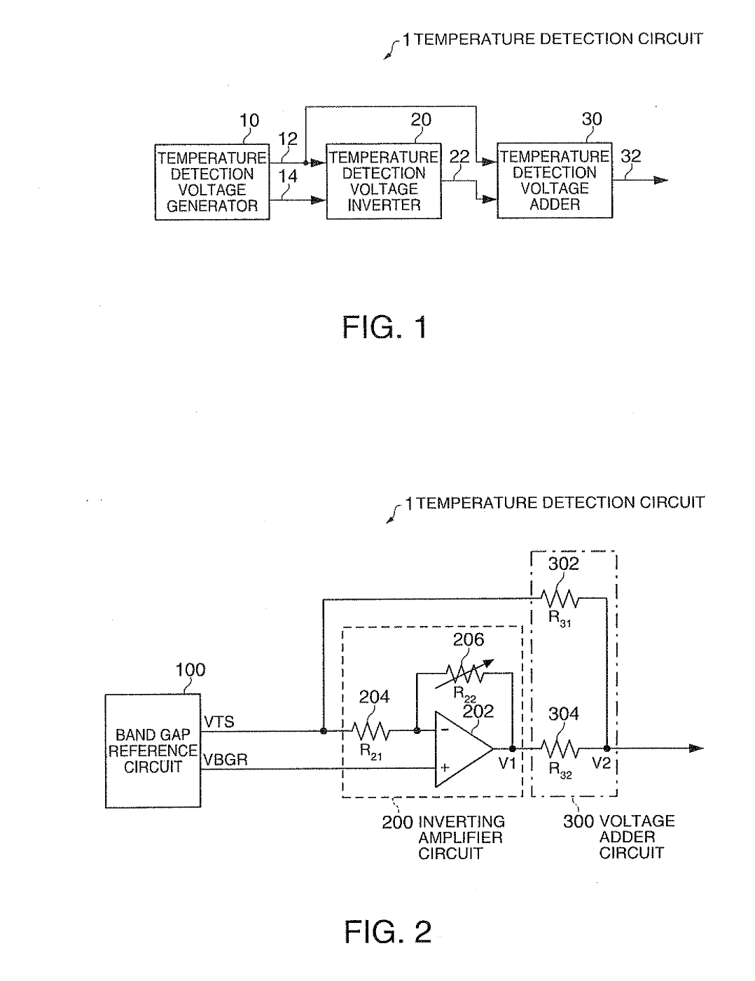

FIG. 1 is a functional block diagram of a temperature detection circuit of a first embodiment. The temperature detection circuit 1 of the first embodiment includes a temperature detection voltage generator 10, a temperature detection voltage inverter 20, and a temperature detection voltage adder 30. In addition, the temperature detection circuit 1 of the present embodiment may have a configuration in which some of these components (elements) are omitted.

The temperature detection voltage generator 10 generates a first temperature detection voltage 12 of which the voltage level based on a given reference voltage 14 varies according to the temperature.

The temperature detection voltage inverter 20 inverts the reference voltage 14 with reference to the first temperature detection voltage 12, and amplifies or attenuates the reference voltage with a given gain to generate a second temperature detection voltage 22. The gain of the temperature detection voltage inverter 20 may be made variable.

The temperature detection voltage adder 30 adds up the first temperature detection voltage 12 and the second temperature detection voltage 22.

FIG. 2 is a view showing a specific configuration example of the temperature detection circuit of the first embodiment. The temperature detection circuit 1 includes a band gap reference circuit 100 (an example of the temperature detection voltage generator 10), an inverting amplifier circuit 200 (an example of the temperature detection voltage inverter 20), and a voltage adder circuit 300 (an example of the temperature detection voltage adder 30). In addition, the temperature detection circuit 1 of the present embodiment may have a configuration in which some of these components (elements) are omitted.

The band gap reference circuit 100 generates a reference voltage VBGR (an example of the reference voltage 14), and a temperature detection voltage VTS (an example of the first temperature detection voltage 12).

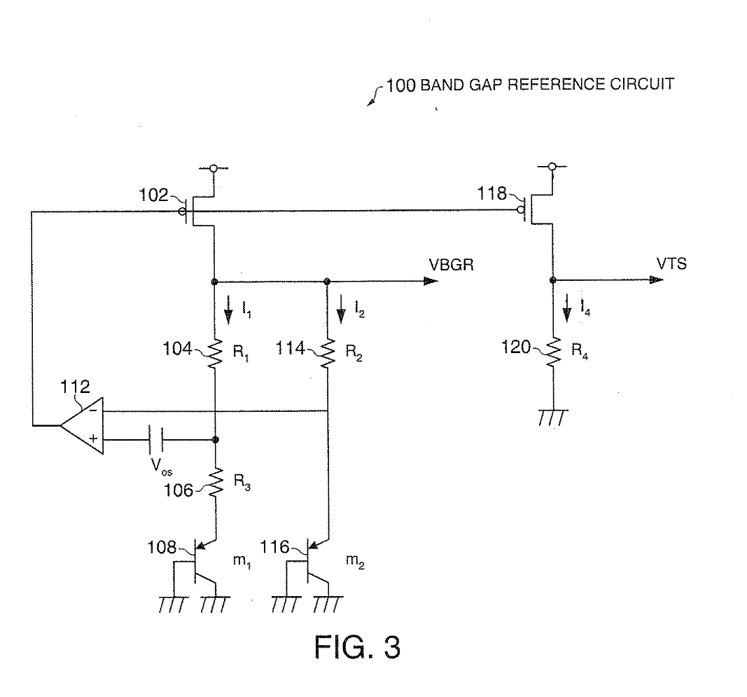

A configuration example of the band gap reference circuit 100 is shown in FIG. 3. The band gap reference circuit 100 includes PMOS transistors 102, 118, resistors 104, 106, 114, and 120, PNP type bipolar transistors 108 and 116, and an operational amplifier 112. The PMOS transistor 102 has a gate terminal connected to an output terminal of the operational amplifier 112, a source terminal connected to a power source, and a drain terminal connected to a first terminal of a resistor 104 (resistance value R₁) and a first terminal of a resistor 114 (resistance value R₂). A second terminal of the resistor 104 is connected to a first terminal of a resistor 106 (resistance value R₃), and a second terminal of the resistor 106 commonly connected to emitter terminals of m₁ PNP type bipolar transistors 108. All the base terminals and collector terminals of the m₁ PNP type bipolar transistors 108 are connected to the ground. That is, m₁ PN diodes are formed between the second terminal of the resistor 106, and the ground. A second terminal of the resistor 114 is commonly connected to emitter terminals of m₂ PNP type bipolar transistors 116, and all the base terminals and collector terminals of the m₂ PNP type bipolar transistors 116 are connected to the ground. That is, m₂ PN diodes are formed between the second terminal of the resistor 114, and the ground.

The operational amplifier 112 has an inverting input terminal (− input terminal) commonly connected to the second terminal of the resistor 114 and the emitter terminals of the m₂ PNP type bipolar transistors 116, and a noninverting input terminal (+ input terminal) connected to the second terminal of the resistor 104, and the first terminal of the resistor 106 via an offset voltage Vos. Additionally, the gate terminal of the PMOS transistor 102 and a gate terminal of the PMOS transistor 118 are connected to an output terminal of the operational amplifier 112. The PMOS transistor 118 has a source terminal connected to a power source and a drain terminal connected to a first terminal of a resistor 120 (resistance value R₄). A second terminal of the resistor 120 is connected to the ground.

In the band gap reference circuit 100 of such a configuration, the voltage VBGR of connection points between the drain terminal of the PMOS transistor 102, and the first terminal of the resistor 104 and the first terminal of the resistor 114 (reference voltage) is calculated by the following Formula (1). Additionally, the voltage VTS (temperature detection voltage) of a connection point between the drain terminal of the PMOS transistor 118 and the first terminal of the resistor 120 is calculated by the following Formula (2).

$$\begin{matrix}VBGR = \frac{α \cdot {R}_{2}}{{R}_{3}} \cdot \{ \frac{k \cdot T}{q} \cdot ln ( α \cdot m ) - {V}_{OS} \} + \frac{k \cdot T}{q} \cdot ln ( \frac{α}{{I}_{S}} \cdot \frac{1}{{R}_{3}} \cdot \{ \frac{k \cdot T}{q} \cdot ln ( α \cdot m ) - {V}_{OS} \} ) & ( 1 ) \\ VTS = \frac{β \cdot {R}_{4}}{{R}_{3}} \cdot \{ \frac{k \cdot T}{q} \cdot ln ( α \cdot m ) - {V}_{OS} \} & ( 2 )\end{matrix}$$

In Formulas (1) and (2), k is Boltzmann's constant, q is quantum of electricity, T is temperature, and Iₛ is a leakage current (reverse saturation current) when a reverse voltage is applied to a PN diode. Additionally, α=I₂/I₁ and β=I₄/I₁ are established with respect to a current I₁ that flows through the resistor 104, a current I₂ that flows through the resistor 114, and a current I₄ that flows through the resistor 120. Additionally, m=m₁/m₂ is established.

R₂, R₃, α, β, and m are adjusted such that the reference voltage VBGR shown in Formula (1) becomes almost constant without being dependent on the temperature T. On the other hand, the temperature detection voltage VTS shown in Formula (2) varies linearly with the value of T, and R₃, R₄, α, β, and m are adjusted so as to coincide with VBGR at a reference temperature T₀ (for example, 25 degrees). That is, the temperature detection voltage VTS calculated in Formula (2) can be expressed like the following Formula (3) using a primary temperature coefficient A.

VTS=A·(T−T₀)+VBGR (3)

Referring back to FIG. 2, the inverting amplifier circuit 200 includes an operational amplifier 202, a resistor 204 (resistance value R₂₁), and a variable resistor 206 (resistance value R₂₂). The resistor 204 has a first terminal supplied with the temperature detection voltage VTS generated by the band gap reference circuit 100 and a second terminal connected to an inverting input terminal (− input terminal) of the operational amplifier 202 and a first terminal of the variable resistor 206. A second terminal of the variable resistor 206 is connected to an output terminal of the operational amplifier 202, and the reference voltage VBGR generated by the band gap reference circuit 100 is supplied to a noninverting input terminal (+ input terminal) of the operational amplifier 202. Through such a configuration, an output voltage (an output voltage of the operational amplifier 202) V1 (an example of the second temperature detection voltage 22) of the inverting amplifier circuit 200 is calculated by the following Formula (4).

$$V 1 = - \frac{{R}_{22}}{{R}_{21}} ( VTS - VBGR ) + VBGR \qquad ( 4 )$$

The voltage adder circuit 300 includes a resistor 302 (resistance value R₃₁) and a resistor 304 (resistance value R₃₂). A first terminal of the resistor 302 is supplied with the temperature detection voltage VTS generated by the band gap reference circuit 100, a first terminal of the resistor 304 is supplied with an output voltage V1 of the inverting amplifier circuit 200, and a second terminal of the resistor 302 and a second terminal of the resistor 304 are connected together. The resistor 302 and the resistor 304 function as resistors for measures against the conflict between the temperature detection voltage VTS and the output voltage V1 of the inverting amplifier circuit 200, and an output voltage (the voltage of a connection point between the second terminal of the resistor 302 and the second terminal of the resistor 304) V2 of the voltage adder circuit 300 is calculated by the following Formula (5). This voltage V2 is the output voltage of the temperature detection circuit 1.

$$V 2 = \frac{{R}_{32} \cdot VTS + {R}_{31} \cdot V 1}{{R}_{31} + {R}_{32}} \qquad ( 5 )$$

Since the noise superimposed on the temperature detection voltage VTS generated by the band gap reference circuit 100 and the noise superimposed on the output voltage V1 of the inverting amplifier circuit 200 ideally differ by about 180° in phase, the noise level (particularly, 1/f noise) of the output voltage (temperature detection voltage) V2 of the temperature detection circuit 1 can be reduced by adding up VTS and V1 by the voltage adder circuit 300 according to Formula (5).

When Formula (4) is substituted into Formula (5) and rearranged, V2 is expressed by the following Formula (6).

$$V 2 = \frac{{R}_{21} \cdot {R}_{32} - {R}_{22} \cdot {R}_{31}}{{R}_{21} \cdot ( {R}_{31} + {R}_{32} )} ( VTS - VBGR ) + VBGR \qquad ( 6 )$$

When Formula (3) is substituted into Formula (6), V2 is expressed by the following Formula (7) and the primary temperature coefficient B of V2 is expressed by Formula (8).

$$\begin{matrix}V 2 = \frac{{R}_{21} \cdot {R}_{32} - {R}_{22} \cdot {R}_{31}}{{R}_{21} \cdot ( {R}_{31} + {R}_{32} )} \cdot A \cdot ( T - {T}_{0} ) + VBGR & ( 7 ) \\ B = \frac{{R}_{21} \cdot {R}_{32} - {R}_{22} \cdot {R}_{31}}{{R}_{21} \cdot ( {R}_{31} + {R}_{32} )} \cdot A & ( 8 )\end{matrix}$$

From Formula (8), the temperature coefficient B of the temperature detection voltage V2 obtained by adding up the temperature detection voltage VTS and the output voltage V1 of the inverting amplifier circuit 200 varies according to the resistance values R₂₁, R₂₂, R₃₁, and R₃₂ (the gain of the inverting amplifier circuit 200). Accordingly, the primary temperature coefficient B of the temperature detection voltage V2 can be set to desired values by appropriately setting the values of R₂₁, R₂₂, R₃₁, and R₃₂. In so doing, for example, the temperature detection voltage V2 can be used as a temperature compensation voltage as is. For example, the absolute value of the primary temperature coefficient B of V2 can be made smaller than the absolute value of the primary temperature coefficient A of VTS by setting R₂₁, R₂₂, R₃₁, and R₃₂ so as to satisfy the following Formula (9).

$$\vert \frac{{R}_{21} \cdot {R}_{32} - {R}_{22} \cdot {R}_{31}}{{R}_{21} \cdot ( {R}_{31} + {R}_{32} )} \vert < 1 \qquad ( 9 )$$

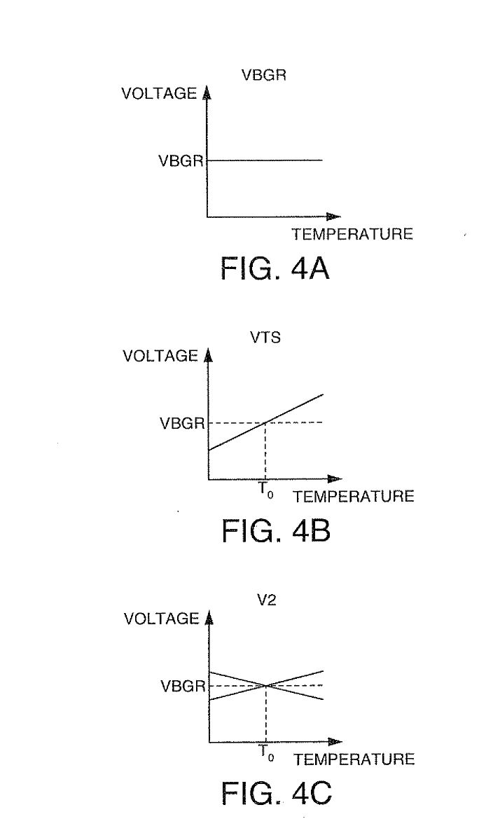

Examples of the temperature characteristics of VBGR, VTS, and V2 are shown in FIGS. 4A to 4C, respectively. In FIGS. 4A to 4C, the horizontal axis represents temperature, and the vertical axis represents voltage. For example, if Formula (7) is calculated as R₂₂=2R₂₁ and R₃₁=R₃₂, V2=−½·A·(T−T₀)+VBGR is established, and the output voltage V2 of the temperature detection circuit 1 becomes a temperature detection voltage that has a temperature coefficient of ½ of VTS with VBGR as a reference voltage. Additionally, for example, if Formula (7) is calculated as R₂₁=2R₂₂ and R₃₁=R₃₂, V2=¼·A·(T−T₀)+VBGR is established, and the output voltage V2 of the temperature detection circuit 1 becomes a temperature detection voltage that has a temperature coefficient of ¼ of VTS with VBGR as a reference voltage.

Additionally, the temperature coefficient B of the temperature detection voltage V2 can be finely adjusted by adjusting the resistance value R₂₂ of the variable resistor 206. For example, the temperature coefficient B of the output voltage V2 of the temperature detection circuit 1 can be kept almost constant by appropriately adjusting the resistance value R₂₂ of the variable resistor 206 so as to correspond to a variation in the temperature coefficient A of the temperature detection voltage VTS.

Moreover, by setting the resistance values R₂₁, R₂₂, R₃₁, and R₃₂ so as to satisfy Formula (9), an adjustment step can be made fine as compared to a case where the temperature coefficient of the temperature detection voltage VTS is adjusted to a desired value only with the inverting amplifier circuit 200 (a case where there is no voltage adder circuit 300).

### (2) Second Embodiment

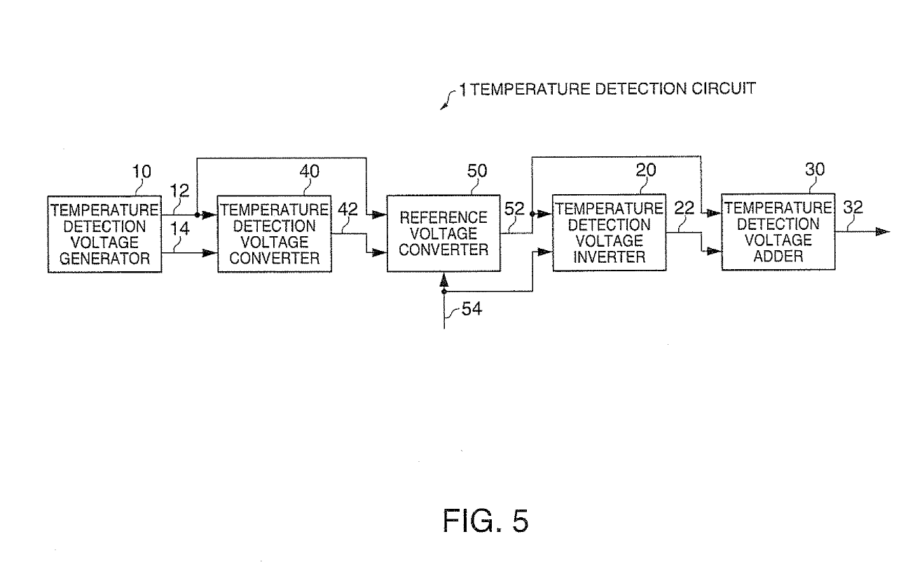

FIG. 5 is a functional block diagram of a temperature detection circuit of a second embodiment. The temperature detection circuit 1 of the second embodiment includes the temperature detection voltage generator 10, a temperature detection voltage converter 40, a reference voltage converter 50, the temperature detection voltage inverter 20, and the temperature detection voltage adder 30. In addition, the temperature detection circuit 1 of the present embodiment may have a configuration in which some of these components (elements) are omitted.

The temperature detection voltage generator 10 generates a first temperature detection voltage 12 of which the voltage level based on a first reference voltage 14 varies according to the temperature.

The temperature detection voltage converter 40 amplifies or attenuates the first temperature detection voltage 12 on the basis of the first reference voltage 14 so as be converted into a second temperature detection voltage 42. The temperature detection voltage converter 40 may invert and amplify or attenuate the first temperature detection voltage 12 on the basis of the first reference voltage 14 to generate the second temperature detection voltage 42.

The reference voltage converter 50 converts the second temperature detection voltage 42 into a third temperature detection voltage 52 of which the voltage level based on the second reference voltage 54 varies according to the temperature. The reference voltage converter 50 may amplify or attenuate the difference between the first temperature detection voltage 12 and the second temperature detection voltage 42 on the basis of the second reference voltage 54 to generate the third temperature detection voltage 52.

The temperature detection voltage inverter 20 may invert and amplify or attenuate the third temperature detection voltage 52 on the basis of the second reference voltage 54 to generate a fourth temperature detection voltage 22. The gain of the temperature detection voltage inverter 20 may be made variable.

The temperature detection voltage adder 30 adds up the third temperature detection voltage 52 and the fourth temperature detection voltage 22.

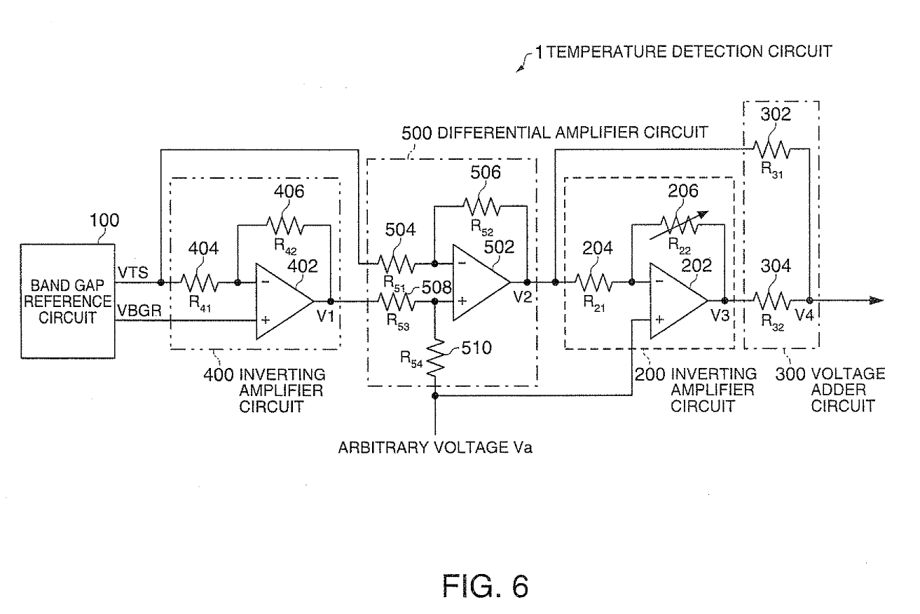

FIG. 6 is a view showing a specific configuration example of the temperature detection circuit of the second embodiment. The temperature detection circuit 1 includes the band gap reference circuit 100 (an example of the temperature detection voltage generator 10), an inverting amplifier circuit 400 (an example of the temperature detection voltage converter 40), a differential amplifier circuit 500 (an example of the reference voltage converter 50), the inverting amplifier circuit 200 (an example of the temperature detection voltage inverter 20), and the voltage adder circuit 300 (an example of the temperature detection voltage adder 30). In addition, the temperature detection circuit 1 of the present embodiment may have a configuration in which some of these components (elements) are omitted.

Since the configuration of the band gap reference circuit 100 is the same as the first embodiment, the illustration and description thereof are omitted.

The inverting amplifier circuit 400 includes an operational amplifier 402, a resistor 404 (resistance value R₄₁), and a resistor 406 (resistance value R₄₂). The resistor 404 has a first terminal, supplied with the temperature detection voltage VTS generated by the band gap reference circuit 100 and a second terminal connected to an inverting input terminal (− input terminal) of the operational amplifier 402 and a first terminal of the resistor 406. A second terminal of the resistor 406 is connected to an output terminal of the operational amplifier 402, and the reference voltage VBGR generated by the band gap reference circuit 100 is supplied to a noninverting input terminal (+ input terminal) of the operational amplifier 402. Through such a configuration, an output voltage (an output voltage of the operational amplifier 402) V1 (an example of the second temperature detection voltage 42) of the inverting amplifier circuit 400 is calculated by the following Formula (10).

$$V 1 = - \frac{{R}_{42}}{{R}_{41}} ( VTS - VBGR ) + VBGR \qquad ( 10 )$$

The differential amplifier circuit 500 includes an operational amplifier 502, a resistor 504 (resistance value R₅₁), a resistor 506 (resistance value R₅₂), a resistor 508 (resistance value R₅₃), and a resistor 510 (resistance value R₅₄). The resistor 504 has a first terminal supplied with the temperature detection voltage VTS generated by the band gap reference circuit 100 and a second terminal connected to an inverting input terminal (− input terminal) of the operational amplifier 502 and a first terminal of the resistor 506. A second terminal of the resistor 506 is connected to an output terminal of the operational amplifier 502. The resistor 508 has a first terminal supplied with the output voltage V1 of the inverting amplifier 400 and a second terminal connected to a noninverting input terminal (+ input terminal) of the operational amplifier 502, and a first terminal of the resistor 510. An arbitrary voltage Va (an example of the second reference voltage 54) is supplied to a second terminal of the resistor 510. Through such configuration, an output voltage (an output voltage of the operational amplifier 502) V2 (an example of the third temperature detection voltage 52) of the differential amplifier circuit 500 is calculated by the following Formula (11).

$$V 2 = - \frac{{R}_{52}}{{R}_{51}} ( VTS - \frac{{R}_{51} + {R}_{52}}{{R}_{52}} \cdot \frac{{R}_{54}}{{R}_{53} + {R}_{54}} \cdot V 1 ) + \frac{{R}_{51} + {R}_{52}}{{R}_{51}} \cdot \frac{{R}_{53}}{{R}_{53} + {R}_{54}} \cdot Va \qquad ( 11 )$$

Here, when setting of R₅₁=R₅₃ and R₅₂=R₅₄ is made, V2 is expressed as in the following Formula (12).

$$V 2 = - \frac{{R}_{52}}{{R}_{51}} ( VTS - V 1 ) + Va \qquad ( 12 )$$

When Formula (10) is substituted into Formula (12) and adjusted, V2 is expressed by the following Formula (13).

$$V 2 = - \frac{{R}_{52}}{{R}_{51}} \cdot \frac{{R}_{41} + {R}_{42}}{{R}_{41}} \cdot ( VTS - VBGR ) + Va \qquad ( 13 )$$

When Formula (3) is substituted into Formula (13), V2 is expressed by the following Formula (14).

$$V 2 = - \frac{{R}_{52}}{{R}_{51}} \cdot \frac{{R}_{41} + {R}_{42}}{{R}_{41}} \cdot A \cdot ( T - {T}_{0} ) + Va \qquad ( 14 )$$

Since V2=Va is established from Formula (14) at the time of T=T₀, the reference voltage of V2 is Va. That is, the reference voltage of VTS is VBGR, whereas the reference voltage is converted into Va with the output of the differential amplifier circuit 500.

The inverting amplifier circuit 200 includes the operational amplifier 202, the resistor 204 (resistance value R₂₁), and the variable resistor 206 (resistance value R₂₂). The resistor 204 has a first terminal supplied with the output voltage V2 of the differential amplifier circuit 500 and a second terminal connected to the inverting input terminal (− input terminal) of the operational amplifier 202, and the first terminal of the variable resistor 206. A second terminal of the variable resistor 206 is connected to an output terminal of the operational amplifier 202, and the arbitrary voltage Va is supplied to a noninverting input terminal (+ input terminal) of the operational amplifier 202. Through such a configuration, an output voltage (an output voltage of the operational amplifier 202) V3 (an example of the fourth temperature detection voltage 22) of the inverting amplifier circuit 200 is calculated by the following Formula (15).

$$V 3 = - \frac{{R}_{22}}{{R}_{21}} ( V 2 - Va ) + Va \qquad ( 15 )$$

The voltage adder circuit 300 includes the resistor 302 (resistance value R₃₁) and the resistor 304 (resistance value R₃₂). The output voltage V2 of the differential amplifier circuit 500 is supplied to the first terminal of the resistor 302, the output voltage V3 of the inverting amplifier circuit 200 is supplied to the first terminal of the resistor 304, and the second terminal of the resistor 302 and the second terminal of the resistor 304 are connected together. The resistor 302 and the resistor 304 function as resistors for measures against the conflict between the output voltage V2 of the differential amplifier circuit 500 and the output voltage V3 of the inverting amplifier circuit 200, and the output voltage (the voltage of a connection point between the second terminal of the resistor 302 and the second terminal of the resistor 304) V4 of the voltage adder circuit 300 is calculated by the following Formula (16). This voltage V4 is the output voltage of the temperature detection circuit 1.

$$V 4 = \frac{{R}_{32} \cdot V 2 + {R}_{31} \cdot V 3}{{R}_{31} + {R}_{32}} \qquad ( 16 )$$

Since the noise superimposed on the output voltage V2 of the differential amplifier circuit 500 and the noise superimposed on the output voltage V3 of the inverting amplifier circuit 200 ideally differ in phase by about 180 degrees, the noise level (particularly, 1/f noise) of the output voltage (temperature detection voltage) V4 of the temperature detection circuit 1 can be reduced by adding up V2 and V3 by the voltage adder circuit 300 according to Formula (16).

When Formula (15) is substituted into Formula (16) and arranged, V4 is expressed by the following Formula (17).

$$V 4 = \frac{{R}_{21} \cdot {R}_{32} - {R}_{22} \cdot {R}_{31}}{{R}_{21} \cdot ( {R}_{31} + {R}_{32} )} ( V 2 - Va ) + Va \qquad ( 17 )$$

When Formula (14) is substituted into Formula (17), V4 is expressed by the following Formula (18) and the primary temperature coefficient C of V4 is expressed by Formula (19).

$$\begin{matrix}V 4 = - \frac{{R}_{21} \cdot {R}_{32} \cdot - {R}_{22} \cdot {R}_{31}}{{R}_{21} \cdot ( {R}_{31} + {R}_{32} )} \cdot \frac{{R}_{52}}{{R}_{51}} \cdot \frac{{R}_{41} + {R}_{42}}{{R}_{41}} \cdot A \cdot ( T - {T}_{0} ) + Va & ( 18 ) \\ C = - \frac{{R}_{21} {R}_{32} - {R}_{22} \cdot {R}_{31}}{{R}_{21} \cdot ( {R}_{31} + {R}_{32} )} \cdot \frac{{R}_{52}}{{R}_{51}} \cdot \frac{{R}_{41} + {R}_{42}}{{R}_{41}} \cdot A & ( 19 )\end{matrix}$$

From Formula (19), the temperature coefficient C of the temperature detection voltage V4 obtained by adding up the output voltage V2 of the differential amplifier circuit 500 and the output voltage V3 of the inverting amplifier circuit 200 varies according to the resistance values R₂₁, R₂₂, R₃₁, R₃₂, R₄₁, R₄₂, R₅₁, and R₅₂ (the gain of the inverting amplifier circuit 200). Accordingly, the primary temperature coefficient C of the temperature detection voltage V4 can be set to desired values by appropriately setting the values of R₂₁, R₂₂, R₃₁, R₃₂, R₄₁, R₄₂, R₅₁, and R₅₂. By operating in this way, for example, the temperature detection voltage V4 can be used as a temperature compensation voltage as is. For example, the absolute value of the primary temperature coefficient C of V4 can be made smaller than the absolute value of the primary temperature coefficient A of VTS by setting R₂₁, R₂₂, R₃₁, R₃₂, R₄₁, R₄₂, R₅₁, and R₅₂ so as to satisfy the following Formula (20).

$$\vert - \frac{{R}_{21} \cdot {R}_{32} - {R}_{22} \cdot {R}_{31}}{{R}_{21} \cdot ( {R}_{31} + {R}_{32} )} \cdot \frac{{R}_{52}}{{R}_{51}} \cdot \frac{{R}_{41} + {R}_{42}}{{R}_{41}} \vert < 1 \qquad ( 20 )$$

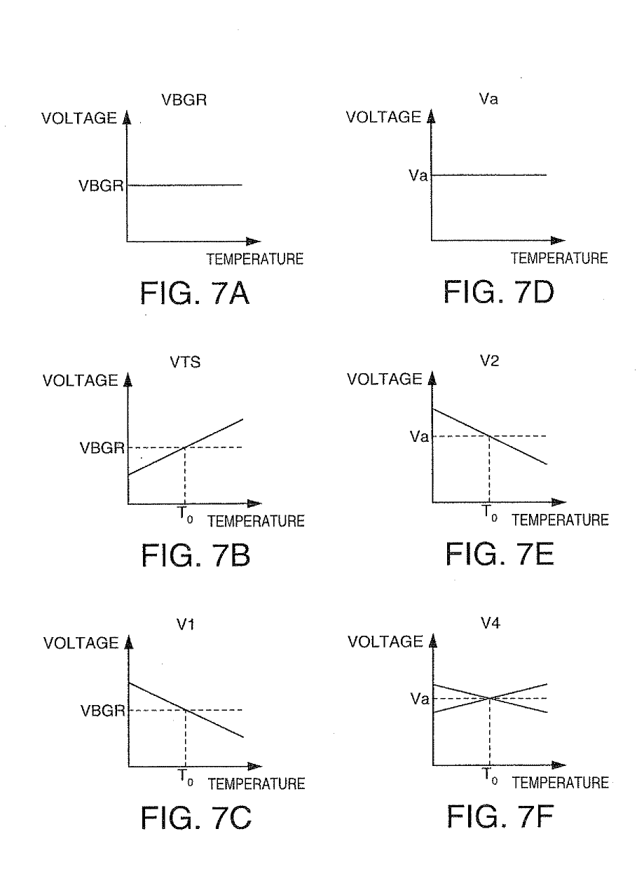

Examples of the temperature characteristics of VBGR, VTS, V1, Va, V2, and V4 are shown in FIGS. 7A to 7F, respectively. In FIGS. 7A to 7F the horizontal axis represents temperature, and the vertical axis represents voltage. For example, if Formula (18) is calculated as R₂₂=2R₂₁, R₃₁=R₃₂, R₄₁=R₄₁—R₄₂, and R₅₁=2R₅₂, V4=−½·A·(T−T₀)+Va is established, and the output voltage V4 of the temperature detection circuit 1 becomes a temperature detection voltage that has a temperature coefficient of ½ of VTS with the arbitrary voltage Va as a reference voltage. Additionally, if Formula (18) is calculated as R₂₁=2R₂₂, R₃₁=R₃₂, R₄₁=R₄₂, and R₅₁=2R₅₂, V4=−¼·A·(T−T₀)+Va is established, and the output voltage V4 of the temperature detection circuit 1 becomes a temperature detection voltage that has a temperature coefficient of ¼ of VTS with the arbitrary voltage Va as a reference voltage.

Additionally, the temperature coefficient C of the temperature detection voltage V4 can be finely adjusted by adjusting the resistance value R₂₂ of the variable resistor 206. For example, the temperature coefficient C of the output voltage V4 of the temperature detection circuit 1 can be kept almost constant by appropriately adjusting the resistance value R₂₂ of the variable resistor 206 so as to correspond to a variation in the temperature coefficient of the temperature detection voltage V2.

Moreover, by setting the resistance values R₂₁, R₂₂, R₃₁, R₃₂, R₄₁, R₄₂, R₅₁, and R₅₂ so as to satisfy Formula (20), an adjustment step can be made fine as compared to a case where the temperature coefficient of the temperature detection voltage V2 is adjusted to a desired value only with the inverting amplifier circuit 200 (a case where there is no voltage adder circuit 300).

Additionally, according to the present embodiment, the reference voltage of the temperature detection voltage V4 can be set to the arbitrary voltage Va regardless of the reference voltage VBGR by the differential amplifier circuit 500. Thereby, since the reference voltage of the output voltage V4 of the temperature detection circuit 1 is also set to Va, the design of the temperature compensation circuit can be facilitated, for example, by making Va the same voltage as the analog ground voltage of the temperature compensation circuit.

### 2. Sensor Device

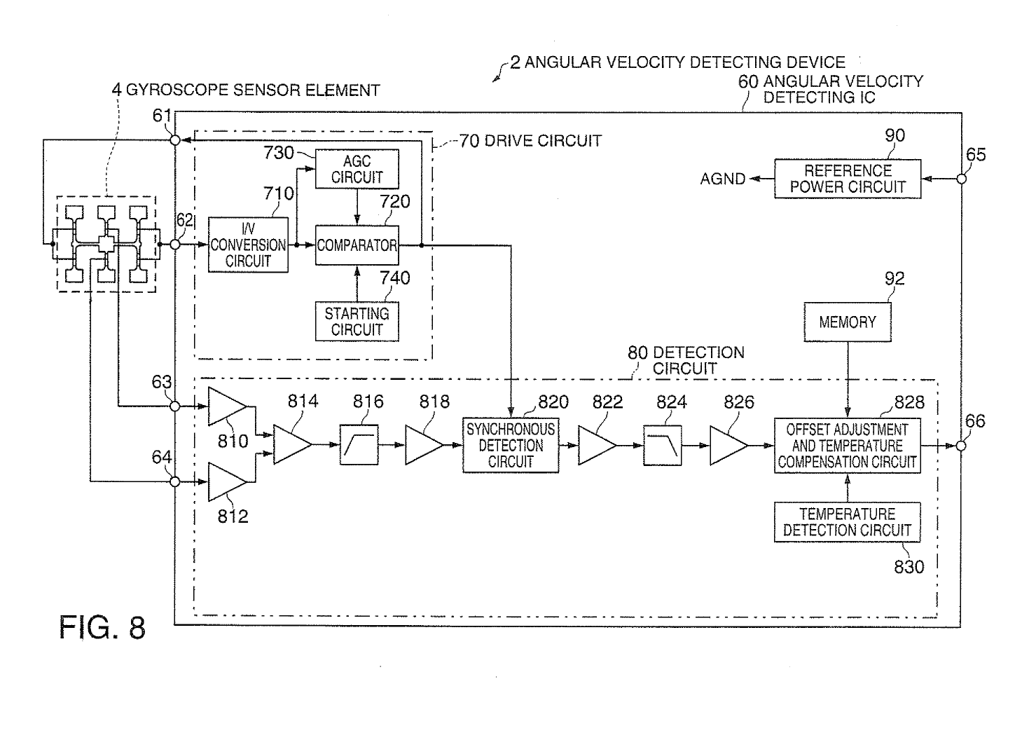

FIG. 8 is a view showing a configuration example of an angular velocity detecting device that is an example of a sensor device. The invention can be applied to a device that detects any of various physical quantities, such as acceleration, angular acceleration, force, and magnetism, in addition to the angular velocity detecting device.

The angular velocity detecting device 2 of the present embodiment includes a vibration type gyroscope sensor element 4, and an angular velocity detecting IC 60.

The gyroscope sensor element 4 is configured such that a vibrating piece at which a driving electrode and a detecting electrode are arranged is sealed by a package (not shown). The vibrating piece of the gyroscope sensor element 4 may be made using piezoelectric materials, for example, including piezoelectric single crystals, such as crystal (SaO₂), lithium tantalite (LiTaO₃), and lithium niobate (LiNbO₃) or piezoelectric ceramics, such as lead zirconate titanate (PZT), and may have a structure in which a piezoelectric thin film, such as zinc oxide (ZnO) or aluminum nitride (AlN), which is pinched by the driving electrode, is arranged on a portion of the surface of a silicon semiconductor.

In the present embodiment, the gyroscope sensor element 4 is constituted by a so-called double T-type vibrating piece that has two driving vibrating arms and one detection vibrating arm therebetween. Here, the vibrating piece of the gyroscope sensor element 4 may be, for example, a tuning fork type, or may be tuning fork types of shapes, such a triangular prism, a quadrangular prism, and a cylinder. Additionally, a silicon semiconductor substrate is worked into a comb-tooth shape.

Two driving electrodes are formed at the two driving vibrating arms, respectively, and are connected to a drive circuit 70 via an external output terminal 61 of the angular velocity detecting IC 60 and an external input terminal 62.

A detecting electrode is formed at a detection vibrating arm 102, and is connected to a detection circuit 80 via external input terminals 63 and 64 of the angular velocity detecting IC 60.

The two driving vibrating arms perform bending vibration (excited vibration) in which mutual distal ends repeat approach and separation due to an inverse piezoelectric effect, if an alternating voltage is applied as a driving signal. Since the two driving vibrating arms perform bending vibration in an always line-symmetrical relation with respect to the detection vibrating arm if the amplitudes of the bending vibration of the two driving vibrating arms are equal, the detection vibrating arm does not cause vibration.

In this state, if the angular velocity having an axis perpendicular to an excited vibration plane as the axis of rotation is applied to the vibrating piece of the gyroscope sensor element 4, the two driving vibrating arms obtain a Coriolis force in a direction perpendicular to both the direction of bending vibration and the axis of rotation. As a result, the symmetric property of the bending vibration of the two driving vibrating arms collapses, and the detection vibrating arm performs bending vibration so as to maintain balance. The bending vibration of the detection vibrating arm and the bending vibration (excited vibration) of the driving vibrating arms accompanying this Coriolis force are shifted by 90° in phase with respect to each other.

In addition, since the amplitudes of the bending vibration of the two driving vibrating arms are slightly different in practice even if the Coriolis force is not applied, the detection vibrating arm performs bending vibration slightly so as to maintain balance. This bending vibration is referred to as leak vibration, and has the same phase as the driving signal. An alternating-current charge based on this bending vibration is generated at the detecting electrode of the detection vibrating arm due to the piezoelectric effect. The alternating-current charge generated on the basis of the Coriolis force varies according to the magnitude (in other words, the magnitude of the angular velocity applied to the gyroscope sensor element 4 ) of the Coriolis force, whereas the alternating-current charge generated on the basis of the leakage vibration is constant regardless of the magnitude of the angular velocity applied to the gyroscope sensor element 4.

The angular velocity detecting IC 60 includes the drive circuit 70, the detection circuit 80, a reference power circuit 90, and a memory 92.

The reference power circuit 90 generates an analog ground voltage AGND (for example, VDD/2) that becomes the reference for the operation of each circuit block from a supply voltage VDD supplied via the power source input terminal 65.

The drive circuit 70 includes an I/V conversion circuit (current voltage conversion circuit) 710, a comparator 720, an AGC (Automatic Gain Control) circuit 730, and a starting circuit 740.

A driving current that has flowed into the vibrating piece of the gyroscope sensor element 4 is converted into an alternating voltage signal by the I/V conversion circuit 710.

The alternating voltage signal output from the I/V conversion circuit 710 is input to the comparator 720 and the AGC circuit 730. The comparator 720 converts and outputs the voltage of the input alternating voltage signal into a binarized signal (square wave voltage signal).

The AGC circuit 730 changes the amplitude of the binarized signal that the comparator 720 outputs, according to the amplitude of the alternating voltage signal that the I/V conversion circuit 710 outputs, and controls a driving current so as to be kept constant.

The binarized signal that the comparator 720 outputs is supplied to a driving electrode of the vibrating piece of the gyroscope sensor element 4 via the external output terminal 61.

In this way, the gyroscope sensor element 4 continues exciting predetermined driving vibration through an oscillation loop via the drive circuit 70. Additionally, the two driving vibrating arms of the gyroscope sensor element 4 can obtain constant vibration velocity by keeping the driving current constant. Therefore, the vibration velocity that serves as the source of generating the Coriolis force becomes constant, and sensitivity can be made more stable.

In addition, the starting circuit 740 includes an oscillation source for making the gyroscope sensor element 4 start bending vibration at the time of the input of a power source or the like, and is separated from an oscillation loop if the amplitude of the alternating voltage signal that the I/V conversion circuit 710 outputs exceeds a predetermined threshold.

The detection circuit 80 includes charge amplifiers 810 and 812, a differential amplifier 814, a high-pass filter 816, an amplifier 818, a synchronous detection circuit 820, an amplifier 822, a low-pass filter 824, an amplifier 826, an offset adjustment and temperature compensation circuit 828, and a temperature detection circuit 830.

An alternating-current charge including an angular velocity component and a vibration leakage component is input to the charge amplifier 810 via an external input terminal 63 from the detecting electrode of the vibrating piece of the gyroscope sensor element 4. Similarly, an alternating-current charge including an angular velocity component and a vibration leakage component is input to the charge amplifier 812 via an external input terminal 64 from the detecting electrode of the vibrating piece of the gyroscope sensor element 4. The charge amplifiers 810 and 812 convert the input alternating-current charges into alternating voltage signals, respectively. The phase of an output signal of the charge amplifier 810 and the phase of an output signal of the charge amplifier 812 are mutually opposite phases (shifted by 180°).

The differential amplifier 814 differentially amplifies the output signal of the charge amplifier 810 and the output signal of the charge amplifier 812. By the differential amplifier 814, in-phase components are canceled and antiphase components are added and amplified.

The high-pass filter 816 cancels a direct-current component included in the output signal of the differential amplifier 814, and the amplifier 818 amplifies the output signal of the high-pass filter 816.

The synchronous detection circuit 820 synchronously detects the output signal of the amplifier 818 with the binarized signal that the comparator 720 outputs. The synchronous detection circuit 820 can be constituted as a switching circuit that selects the output signal of the amplifier 818 as is, for example, when the voltage level of the binarized signal is higher than AGND, and selects a signal obtained by inverting the output signal of the amplifier 818 to AGND when the voltage level of the binarized signal is lower than AGND.

Although the angular velocity component and the vibration leakage component are included in the output signal of amplifier 818, this angular velocity component has the same phase as the binarized signal that the comparator 720 outputs, whereas the vibration leakage component has an opposite phase. Therefore, the angular velocity component is detected by the synchronous detection circuit 820, but the vibration leakage component is not detected.

The amplifier 822 amplifies or attenuates the output signal of the synchronous detection circuit 820 to output a signal with a desired voltage level, and the low-pass filter 824 removes a high-frequency component included in the output signal of amplifier 822, and extracts a signal within a frequency range determined by specification.

The output signal of the low-pass filter 824 is amplified or attenuated to a signal with a desired voltage level by the amplifier 826. The output signal of the amplifier 826 is a signal with a voltage level corresponding to angular velocity on the basis of AGND.

The offset adjustment and temperature compensation circuit 828 cancels an offset voltage according to offset adjustment data set in the memory 410, with respect to the output signal of the amplifier 826, and performs temperature compensation according to the temperature detection voltage that the temperature detection circuit 830 outputs. The output signal of the offset adjustment and temperature compensation circuit 828 is output to the outside via the external output terminal 66 as an angular velocity signal. Here, offset adjustment or temperature compensation is not necessarily performed on the output signal of the amplifier 826, or may be performed at the preceding block.

The temperature detection circuit 830 is, for example, the temperature detection circuit of the present embodiment shown in FIG. 2 or FIG. 6, and outputs a temperature detection voltage with a temperature coefficient that is linear with respect to temperature. The angular velocity detecting device that outputs an angular velocity signal of a low noise can be realized by incorporating the temperature detection circuit of the present embodiment in this way.

In addition, the invention is not limited to the present embodiments, and various modifications can be made within the scope of the invention.

The invention includes substantially the same configuration (for example, a configuration with the same functions, method and results, or a configuration with the same purpose and effects) as the configuration described in the embodiments. Additionally, the invention includes a configuration in which non-essential portions of the configuration described in the embodiments are substituted. Additionally, the invention includes a configuration that can achieve the same configuration or purpose that exhibits the same working effects as the configuration described in the embodiments. Additionally, the invention includes a configuration in which a well-known technique is added to the configuration described in the embodiments.

What is claimed is:

1. A temperature detection circuit comprising:
a temperature detection voltage generator that generates a first temperature detection voltage of which the voltage level based on a given reference voltage varies according to the temperature;
a temperature detection voltage inverter that inverts the first temperature detection voltage on the basis of the reference voltage, and amplifies or attenuates the inverted first temperature detection voltage with a given gain to generate a second temperature detection voltage; and
a temperature detection voltage adder that adds up the first temperature detection voltage and the second temperature detection voltage.

2. A temperature detection circuit comprising:
a temperature detection voltage generator that generates a first temperature detection voltage of which the voltage level based on a first reference voltage varies according to the temperature;
a temperature detection voltage converter that amplifies or attenuates the first temperature detection voltage on the basis of the first reference voltage to convert the amplified or attenuated first temperature detection voltage into a second temperature detection voltage;
a reference voltage converter that converts the second temperature detection voltage into a third temperature detection voltage of which the voltage level based on a second reference voltage varies according to the temperature;
a temperature detection voltage inverter that inverts the third temperature detection voltage on the basis of the second reference voltage, and amplifies or attenuates the inverted third temperature detection voltage with a given gain to generate a fourth temperature detection voltage; and
a temperature detection voltage adder that adds up the third temperature detection voltage and the fourth temperature detection voltage.

3. The temperature detection circuit according to claim 2,
wherein the reference voltage converter amplifies or attenuates the difference between the first temperature detection voltage and the second temperature detection voltage on the basis of the second reference voltage to generate the third temperature detection voltage.

4. The temperature detection circuit according to claim 2,
wherein the temperature detection voltage converter inverts and amplifies or attenuates the first temperature detection voltage on the basis of the first reference voltage, to generate the second temperature detection voltage.

5. The temperature detection circuit according to claim 1,
wherein the gain of the temperature detection voltage inverter is variable.

6. A sensor device comprising the temperature detection circuit according to claim 1.

7. A sensor device comprising the temperature detection circuit according to claim 2.

8. A sensor device comprising the temperature detection circuit according to claim 3.

9. A sensor device comprising the temperature detection circuit according to claim 4.

10. A sensor device comprising the temperature detection circuit according to claim 5.
